(19) United States
(12) Patent Application Publication
(10) Pub. No.: US 2010/0077215 A1
(43) Pub. Date: Mar. 25, 2010

(54) METHOD FOR TRANSMITTING INFORMATION WITH A SEMANTIC ACKNOWLEDGEMENT OF RECEIPT

(76) Inventor: Frederic Placin, Lons (FR)

Correspondence Address: Perman & Green, LLP, 99 Hawley Lane, Stratford, CT, 06614, US

(21) Appl. No.: 12/236,139

(22) Filed: Sep. 23, 2008

(51) Int. Cl. H04L 9/00

(52) U.S. Cl. 713/171

(57) ABSTRACT

The method for transmitting information between an emitter and a receiver includes a phase of authentication of the receiver using a pair of encryption keys of the private key/public key types, a phase of sending a series of information from the emitter to the receiver, a phase of retransmission by the receiver towards the emitter of an acknowledgement of receipt including at least one element semantically associated with the series of information transmitted.

### BACKGROUND

1. Field

The disclosed embodiments relate to the general field of methods for transmitting information. It more particularly relates to a method for emitting information on a network so as to guarantee their correct reception and to check the identity of the receiver of such information. Even more particularly, it relates to an interactive method for broadcasting advertising spots via the Internet against a periodical automatic payment of the Internet user who accepts to receive the advertising spots.

2. Brief Description of Related Developments

When it is desired to obtain the confirmation, from an Internet user, of the correct reception of the set of information, typically the correct reception of an Internet page, problems arise with respect to the sending by an Internet user of an acknowledgement of receipt of the message, and to the authentication that the Internet user sending the acknowledgement of receipt is the one who must receive the information.

As regards the confirmation of the reception of an Internet page, a validation of the inscription through the copy of the visual cryptogram composed of words or letters and figures sent in the form of an image file is currently used in the field of forms on the Internet. This technique is used to attempt to avoid a subscription or an automatic answer by some software. A human being may understand, in an image, a sequence of letters and figures and enter it again with the keypad. Software automatically answering this kind of confirmation of subscription should have a recognition of characters in an image, which would increase the complexity thereof.

As regards the authentication of the Internet user who receives a series of information, an authentication of the Internet user is known in the field of bank sites accessible through the Internet, prior to giving him/her access to his/her account through the entering of a confidential code personal, to each user. Such method has the drawback of a possible interception of the series of keys pressed and thus the lost of the confidential code secrecy. The solution currently chosen consists in giving the Internet client a keyboard in the form of a keypad, the figures of which are randomly distributed on a 4×4 matrix. Then, the Internet user has just to move the pointer of his/her computer mouse on the figures to enter his/her confidential code which prevents the interception of a series of entries on the keyboard.

This solution has the drawback of being slow, the authentication requesting about ten seconds from the Internet user.

Besides, this authentication may then be purely syntaxical and not be connected to the content of the information transmitted.

A method for emitting information, for which it is desired to guarantee the correct reception of the information transmitted and the identity of the receiver should then use both a test of reception and a test of identification. It must be understood that this constraint would make a successive sending of several series of information difficult or even unrealistic.

As regards the particular case of the emission of advertising spots on the Internet, possibly targeted according to the Internet users, the present broadcasting systems are very unsatisfactory in so far as all the computers or cellular phones are equipped with protection systems which block such messages and thus prevent them from being displayed by the user.

### SUMMARY

The present methods and processes for broadcasting advertising messages are passive methods undergone by Internet users, who do their best to protect themselves against the invasion of advertising spots by installing software which blocked such messages and thus prohibit their viewing by the user. Thus, in the present state of the techniques, the companies which wish to broadcast an advertising spot on the Internet pay a very high price without being sure that their message will be viewed by the Internet users. No existing method makes it possible to solve such technical problem met by the advertising spots broadcasters.

The aim of the disclosed embodiments is to overcome such drawbacks by making it possible to guarantee both the correct reception of the information transmitted and the authentication of the receiver, both within a very short time.

A second aim of the disclosed embodiments is to make it possible to check the intelligibility of the information transmitted.

Another aim is to guarantee the correct reception and the authentication in a simple way for the user.

Another aim of the disclosed embodiments is the automatic opening of advertising spots in the Internet home page of the computer or any other Internet user's system which can be connected to the Internet and the automatic payment to the user after the confirmation that such messages have been displayed.

According to the disclosed embodiments, the method for transmitting one or several advertising spot(s) by a server of files to an Internet user's computer, said advertising spots being formatted within an Internet page, said advertising spots being associated with estimations according to n perceptual dimensions, such estimations being stored in a memory of the server, includes:

a step of creating an account wherein:

the user defines his/her name and address and his/her preferences according to the n perceptual dimensions,

a couple of encryption keys of the public and private key types is generated, a public key being stored in a memory of the user's computer together with a unique identifier encrypted with the private key and a private key being stored in a memory of the server together with the unique identifier,

a step of a so-called daily utilisation of the service wherein:

the user's computer is connected by the Internet to the server on the service and sends it its encrypted unique identifier and its public key,

the server decrypts the unique identifier with the public key, then retrieves from its memory the private key associated to such unique identifier and tests the matching of both keys,

the server selects one or several advertising spots on the closeness to the user's perceptual preferences, then generates an Internet page including this or these advertising spot(s) as well as a visual cryptogram and sends it/them to the user,

the user restranscribes the content of the visual cryptogram then the server confirms the correct matching of the retranscribed content and the original content and stores in its memory the correct display of such advertising spot or spots by the user on the day's date.

In an advantageous implementation, the content of the visual cryptogram is semantically associated with the selected advertising spots.

It should be understood that there through, it is possible to check that the Internet user really displayed the advertising spot which was sent and did not simply retranscribed the visual cryptogram in an almost reflex way.

The aim of the disclosed embodiments is more generally a method for transmitting information between an emitter and a receiver, including:

a phase of authentication of the receiver using a pair of encryption keys of the private key/public key types,

a phase of sending a series of information from the emitter to the receiver,

a phase of retransmission by the receiver to the emitter of an acknowledgement of receipt including at least one element semantically associated with the series of information transmitted.

According to a particular implementation, the emitter is a server of digitalized files.

According to a preferred implementation, the element semantically associated to the series of information transmitted is a text transmitted by the emitter as an image, i.e. conventionally a visual cryptogram.

In another embodiment, the element semantically associated with the series of information transmitted is an unscheduled question transmitted with the series of information, with the answer being contained in the series of information transmitted.

In an advantageous alternative solution, such semantic element is coded by a code which is personal to the receiver prior to it being retransmitted.

In a preferred implementation, the receiver is of the computer type and provided with Internet pages display means and the phase of sending the series of information uses a transmission protocol of the Internet type, a series of information being formatted as Internet pages.

In the particular case of the authentication by a public key/private key couple and of the transmission of the information as Internet pages, the public key is advantageously stored in a memory of the receiving computer and the private key is stored in a memory of the files server.

In a preferred implementation, the method includes a phase of storing by the emitter the information transmitted to each receiver.

Preferably, the emitter thus includes a memory wherein a table associating a value to each series of information transmitted is stored, and a memory associated with each receiver, wherein the list of the series of information transmitted to said receiver, the date on which each series of information was transmitted, the sum of the values associated with the series of information transmitted to the receiver from the summation start date, and the summation start date are stored.

More particularly, the emitter includes a memory wherein a set of data characterising the receiver is stored, and a memory wherein is stored a set of data characterising the receiver and a memory wherein a set of data characterising this series is stored, for each series of information liable to be transmitted.

More particularly, the method includes a phase of selecting at least one series of information to be transmitted to the receiver according to criteria associated with the data characterising the receiver, the data characterising the series of information liable to be transmitted and the list of series of information previously transmitted to said receiver.

According to an advantageous mode, the method includes a phase of updating the data characterising the receiver.

In this case, more particularly, the updating uses a valorization by the receiver of each series of information received and a memorization by the emitter of the estimations associated to such series of information transmitted to said receiver.

Advantageously, in the case of transmission of information as Internet pages, the receiving computer includes a memory wherein information able to cause the priority connection with the emitter upon the access of the receiver network is stored.

It should be noted that the user's computer is first connected to the server of files so as to allow the sending of one or several series of information selected prior to the conventional access to the other servers of Internet data.

The description and drawings of a particular embodiment for the particular case of the transmission of Internet pages between a server and a receiving computer, as given hereinunder, making it possible to better understand the aims and advantages of the disclosed embodiments. It is obvious that such description is given as an example and should not be considered as limitative. In the drawings:

### BRIEF DESCRIPTION OF THE DRAWINGS

FIG. 1 is a schematic representation of the elements implied in an Internet connection in the case of the method according to the disclosed embodiments;

FIG. 2 illustrates a flowchart the steps of the initialisation phase of the method;

FIG. 3 similarly illustrates the method for the daily utilisation of the method;

FIG. 4 similarly illustrates the method for the regular reading of parameters on the user's account;

FIG. 5 similarly illustrates the method for modifying the user's data.

In the following part of the description, the emitter of data is composed of one or several file server(s), such files being in form of html pages, adapted to be displayed by an Internet browser of the common type, for example Mozilla Firefox or Internet Explorer. Similarly, the receiver of the data is here an Internet equipped with a device giving access to the Internet network, for example a micro-computer of the so-called PC type, or any other Internet pages display device known per se, such as a mobile telephone etc. The connection between the server and the Internet is performed for example through a wire network under an ADSL protocol, but any other connection and data transfer mode will be also compatible with the method according to the disclosed embodiments without any modification.

### DETAILED DESCRIPTION OF THE DRAWINGS

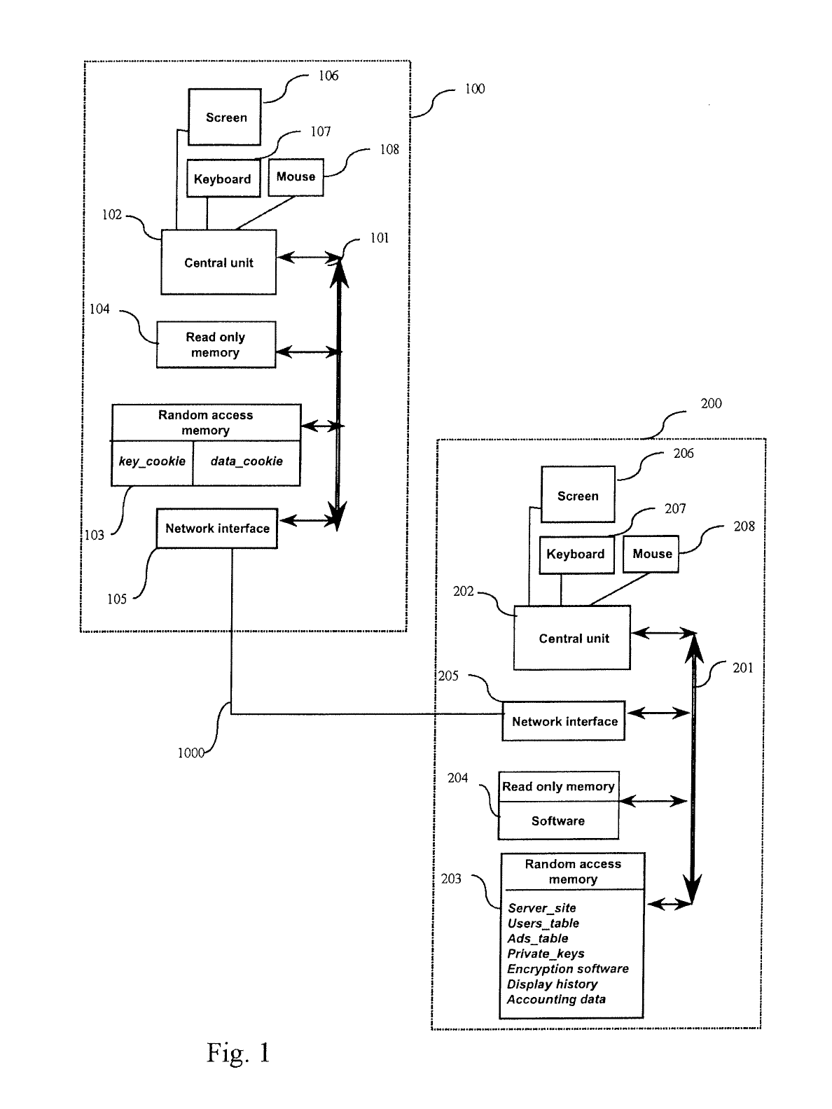

As can be seen on FIG. 1 in the form of a synoptic diagram, in an Internet connection of the conventional type, what is indicated in the description as the receiver is here an Internet access device for example a micro-computer shown with the general reference number 100 and used by an Internet user 1, said device including, connected together by an address and data buss 101:

a central unit 102;

a random access memory RAM 103;

a read only memory 104;

a network interface 105 used to receive, as binary data, series of information, such interface being for example a conventional ADSL modem;

and, independently from the 101 bus:

a display screen 106;

a keyboard 107;

a mouse 108.

A random access memory 103 keeps data, variables and intermediate processing results in memory registers bearing the same names as the data which they keep the values for in the following description. The RAM memory 103 more particularly includes:

a “key_cookie” file wherein an encryption key is kept,

a “data_cookie” file where data specific to the user are kept,

a “server_address” register wherein the address of an Internet server launched in priority upon a connection to the Internet network is kept.

The random access memory 103 is an information storage means which can be read by a computer or a microprocessor. In addition, it keeps data resulting from the implementation of such method.

Similarly, what is called in the description an emitter is here a file server shown under the general reference 200, said server 200 including, connected together through a bus of addresses and data of the server 201:

a server central unit 202;

a server random access memory RAM 203;

a server read only memory ROM 204;

a server interface with the network 205 used for emitting and receiving series of information as binary data.

Such server may be connected to a display screen 206, a keyboard 207, a mouse 208 for the updating of some of the data or software stored in the random access memory 203.

The random access memory 203 keeps data, variables and intermediate processing results in memory registers bearing, in the following description, the same names as the data the values of which they keep. The random access memory 203 more particularly includes:

one or several Internet page(s) in each html language or another language, forming together an Internet network presenting the service offered and a user's interface, such site being mentioned in the following description as a server,

a “users_table” table wherein a table of data relative to the method users according to the disclosed embodiments is kept and among others, for each user of the data preferred by the user.

an “ads_table” table wherein a table of data relative to the series of information to be transmitted is kept, for example advertising banners, text blocks or various animations: video or audio flux, vouchers, invitations, codes of promotions and so on and for each series classification data according to various perceptual dimensions and addresses of images, audio, video, text or Internet pages files associated with each series of information according to various perceptual criteria and a preferred Internet homepage,

a “private_keys” table wherein a specific encryption key is kept for each user identified by its IdCustomer unique identifier,

an “encryption_software” program for the encryption/decryption of data using a pair of keys associated to each user, such software using an algorithm of the conventional type, for example RSA,

a “display_history” table wherein a table for all the series of information displayed by each user is stored with the dates and times of displaying,

an “accounting_data” base wherein dates and values are stored for each user and

a computer program for implementing the method according to the disclosed embodiments.

The RAM memory 203 is a mean for storing the information which can be read by a computer or a microprocessor. It keeps data resulting from the implementation of such method, i.e. coded data.

According to an alternative solution, the RAM memory 203 is removable, either partially or totally.

The read only memory 204 is a means for storing information which can be read by a computer or a microprocessor. It keeps instructions from a computer program which makes it possible to implement the method object of the disclosed embodiments for the part relating to the server 200.

According to an alternative solution, the read only memory 204 is totally or partially removable and includes for example a fixed memory digital optical disc (“a CD-ROM”).

The server 200 and the computer 100 of the Internet user 1 are connected through a network 1000 of a conventional type, able to support the transfer of documents of the Internet type.

Each of the elements illustrated in FIG. 1 is well known by the specialist in the art of computer data transmitting systems and more generally information processing systems. Such elements are not described here.

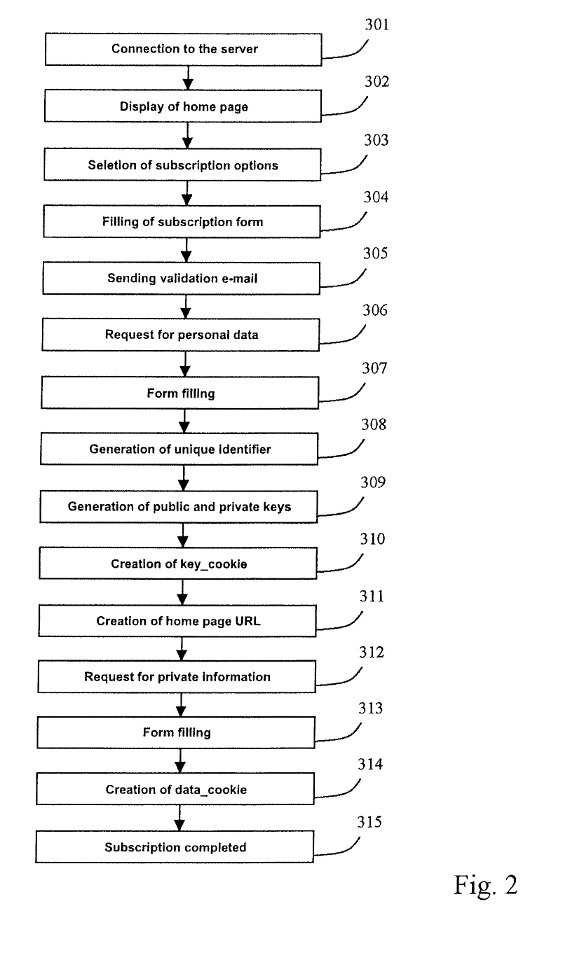

The central unit 102 at the Internet user and the server 202 are designed for implementing the flow diagram described in FIGS. 2, 3 and 4.

FIG. 2 is a diagram of the first step of the method which is the subject of the disclosed embodiments, i.e. the initialisation of the device illustrated in FIG. 1.

The server 200 hosts an Internet site so-called a server site which is accessible to any Internet user. Such Internet site is made using conventional techniques which are known to the person skilled in the art.

During a preliminary step 300, a data basis “ads_table” of the series of information in this case, advertising banners, text blocks or various animations for example video or audio flux, vouchers, invitations, promotional codes etc, has been entered in the server 200 and has a unique identifier AdId for each series of information, a set of characteristics which can be perceived from such series of information according to n previously chosen criteria Ci (1<i<n), as well as the memory or URL addresses of the image, audio, video, text or Internet pages files corresponding to such information series.

During an operation 301, the Internet user 1 willingly connects to the server site hosted by the server 200 for example through the direct entry of the Internet address of said site into the address bar of his/her computer 100, of the http://www.site_server.com.

During an operation 302, the server site displays on the user's 1 screen 106 a homepage Pₐ bearing information on the operation of the user's payment program as a counterpart for displaying the advertising spot by this user.

During an operation 303, the Internet user 1 clicks with the mouse 108 of his/her computer 100 on a subscription icon positioned on the homepage Pₐ of the server site, and is reoriented towards a page Pi of subscription to the abovementioned program. This page is of a secured type for example through the utilisation of an https page transfer protocol.

During an operation 304, the subscription page Pᵢ appears on the user's 1 computer 100. It includes a form for a pre-inscription as well as a visual cryptogram of confirmation of order, of the type known to a specialist in the art and for example including an image on which a series of letters and figures which are deformed and inclined can be distinguished. The user 1 is requested to enter his/her email address on the form and to retranscribe in a field provided therefor the series of letters and figures which he/she saw in a visual cryptogram so as to confirm his/her will to subscribe. Then, he/she must validate the pre-subscription by clicking on a form validation icon.

During an operation 305, the server 200 sends an email containing a unique identification link to the electronic address given by the user 1. The creation of such unique links is of a conventional type for the e-commerce site. The user 1 clicks on the unique identifying link mentioned in the email sent to him or to her by the server 200 and the Internet browser of his/her computer 100 is reoriented towards a personal data page P_{dp} of the server site containing the form of subscription to the user's payment program as a counterpart for displaying by the user 1 of the advertising spots. This page P_{dp} is also of a secured type, for example through the utilisation of a transfer protocol of the https type.

During an operation 306, the personal data page P_{dp} which is displayed on the user's 1 computer 100, prompts the latter to supply personal basic data among which more particularly:

The URLd address of the present defect Internet homepage of the user 1 (the Internet browser defect pages that is displayed upon the launching of the browser);

His/her postal zip code;

His/her birth date

His/her private and professional things of interest determined for example by a series of n questions Qi(1<i<n) which are closed in the form of tick boxes. In this example, each question Qi corresponds to a perceptual criterion Ci characterising the series of information referenced in the “ads_table” table.

During an operation 307, the user 1 fills the form on the personal data page Pp which he/she then validates by clicking on the validation diagram appearing on said form.

During an operation 308, the server 200 generates a unique identifier ClientId for the user 1.

During an operation 309, the server 200 also generates a pair of encryption keys (a private key and a public key) intended to the known utilisation of public key algorithm. The creation of such pairs of encryption keys is known to the man of the art (for example the protocol SSH) and is not described here. The user's 1 private key is recorded in the data base in the server data 200, in a table “private_keys”. The server 200 records the user's 1 unique identifier ClientId and the user's 1 personal data in a “users_table” table of a working database, such information being encrypted using the user's 1 public key.

During an operation 310, in answer to the form received from the user 1 including his/her personal data, the server 200 sends the user's 1 browser the instruction of creating a “cookie”. Such “cookie” file, the creation of which is of a type known to the person skilled in the art is positioned in a memory register “key_cookie” in the user's 1 computer 100. It contains the user's public key and the user's unique identifier ClientId (user's identifying data) encrypted by the server 200 using a private key and an encryption software using an encryption algorithm using two keys of the conventional type, for example RSA.

During an operation 311, the server 200 defines an URLip address for the user's 1 Internet home page P_{dip}, such URLip address being sent to the user's 1 computer 100 and being stored in a conventional way in the user's browser as a new home page of said browser.

During an operation 312, the server 200 sends the user's 1 browser a so-called private information Pᵢₚ page including an interactive form requesting private information, such page being also of a secured type. Such form prompts the user to supply private data along which more particularly:

Name;

Christian names;

Mail address;

Bank references.

During an operation 313, the user 1 fills the form and validates it by clicking on a form validation target icon.

The private data contained in the form are possibly but not necessarily encrypted by the server 200 using the user's 1 private key, then they are sent again to the Internet browser of the user's 1 computer 100 during an operation 314 as a cookie (the server 200 sends the user computer 100 Internet browser an instruction to create a “cookie” containing the personal data on the form), stored in a file “data_cookie”.

During an operation 315, the server 200 displays a page P_{ci} for the confirmation of the user's 1 subscription.

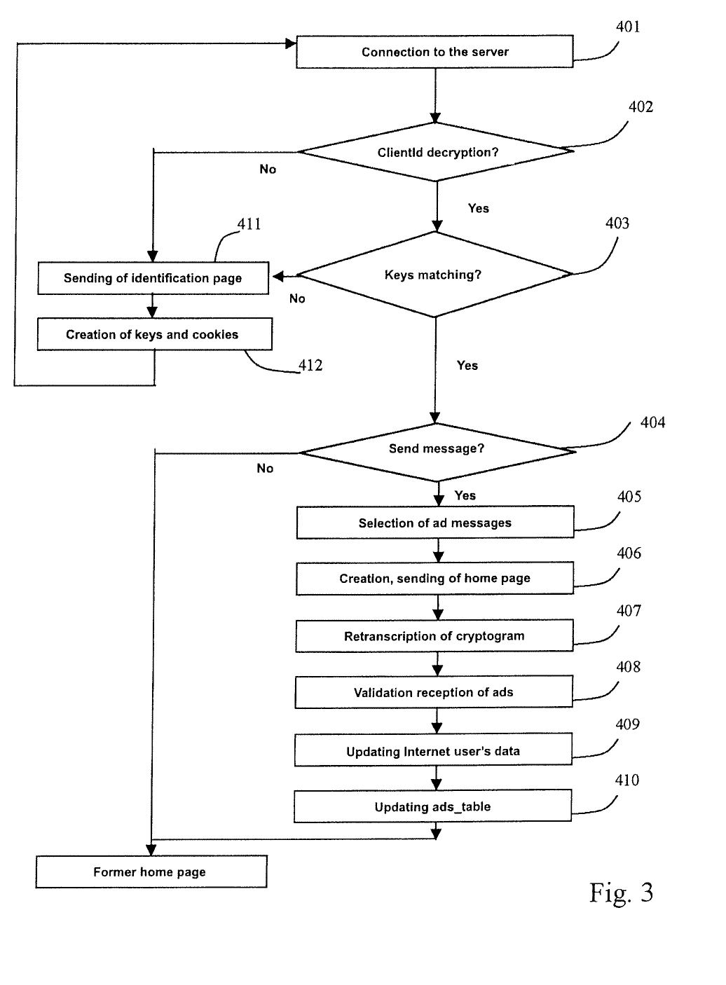

FIG. 3 illustrates the so-called normal utilisation method also called the daily utilisation of the method by the user.

During an operation 401, the user 1 opens the Internet browser which searches the customised home page P_{dip}, the Internet address URLip of which has been defined as a defect home address. The user's 1 computer 100 sends a request of the server 200 for sending the customised homepage P_{dip}.

Simultaneously, the user's 1 computer 100 Internet browser sends to server 200 the key_cookie file containing the encrypted ClientId user's unique identifier and the user's 1 public key.

During an operation 402, the server 200 decrypts the user's 1 ClientId unique identifier, contained in the user's 1 key_cookie file by using the user's public key, such unique identifier having previously as seen at step 313 being encrypted with the private key. The server 200 thus validates the user's 1 public key contained in the key_cookie file.

During an operation 403, the server 200 checks that the pair of public and private keys really matches the user 1 whose unique identifier is ClientId by encrypting with the public key found in the key_cookie file received from the user's 1 computer 100, then by decrypting with the private key found in the “private keys” table and corresponding to the user identified by his/her ClientId unique identifier, such “private_keys” table being stored in the memory of the server 200, the information contained in the key_cookie file. If this encryption/decryption operation succeeded, the keys are valid and the user's 1 computer 100 is thus authenticated. This operation may last a few seconds.

During an operation 404, the server 200 checks whether the user already displayed one or several advertising spots on that same day. As a matter of fact, the utilisation is different depending on the user 1, already inscribed according to steps 301 to 314 mentioned hereabove, is connected for the first time in the day (or an arbitrary selected period of time), or for a second or nth time. For this checking operation, the server 200 accesses the “display_history” base. If, for the date of the day, the “display_history” table contains no elements displayed for the user 1 identified through his/her ClientId unique identifier, the server 200 considers that the user 1 is in his/her first Internet connection of the day.

During an operation 405, the server 200 collects the user's 1 personal information, stored and encrypted in the “users_table” table. The server 200 decrypts such information using the private key (it was mentioned in step 309 that they were encrypted using the user's 1 public key) and selects one or several advertising spot(s) corresponding to the user's personal data (age, geographical location, private and professional interests . . . ).

Such selection may be carried out by a calculation algorithm of the distance of the various series of information (advertising spots in this example) referenced in the “ads_table” table and the user's 1 personal tastes in the n dimension space corresponding to the perceptual criteria Ci. To each series of information corresponds a point of this n-dimension space, determined by the values corresponding to its unique identifier AdId in the “Ads_table” table and to each user also corresponds a point determined by the values corresponding to its ClientId unique identifier in the “users_table” table. During this selection, it is possible to refuse the series of information the “display_history” table shows that they have already been displayed for the user 1 in an arbitrarily lengthy period and for example on that same day.

During an operation 406, the server 200 then generates a customised home page P_{dip} requested by the user's 1 browser. Such customised home page P_{dip} includes all the previously selected advertising spots in the form of banners, text blocks or miscellaneous animations for example video or audio flux, vouchers, invitations, promotions codes etc., supplied by advertisers and the addresses of which are stored in the “Ads_table” register. The previously cited homepage P_{dip} including such miscellaneous elements is then displayed on the screen 106 of the user's 1 computer 100.

At the bottom of the user's 1 customised starting page P_{dip} is positioned a visual cryptogram generated by the server 200 in a conventional way which is known to the person skilled in the art, and that the user 1 must decrypt and then retranscribe by pressing the keyboard during an operation 407. The user 1 thus confirms the closeness of the customised homepage Pdip containing the series of information (advertising) selected by the server 200 and corresponding to the user's 1 taste. In the preferred embodiment, the visual cryptogram includes elements belonging to the series of information transmitted for example words connected to a current advertisement campaign. Such utilisation of elements associated to the semantic contents of the information transmitted makes it possible to validate the effective reading of the information by the user 1 and thus prevents a simple reflex answer.

In an alternative solution, the retranscribed text corresponding to the visual cryptogram is encrypted by the user's 1 computer 100, using his/her public key.

During an operation 408, as soon as the visual cryptogram is validated by the server 200 by comparing the message contained in the cryptogram emitted and the text of such message retranscribed by the user 1 (possibly after the decryption with the user's 1 private key, stored in the “private_keys” table, the server 200 reorients the user's 1 computer 100 Internet browser towards the former address Internet homepage URLd.

During an operation 409, the server 200 records in the “display_history” table the fact that the user 1 identified by the unique identifier ClientId displayed the selected series of information transmitted in the customised homepage P_{dip}.

During an operation 410, the server 200 records in the “ads_table” table for each series of information (advertising) transmitted to the user 1 and validated through the correct reception of the retranscribed visual cryptogram, an increment of the number of times when such series of information was transmitted to all the users, as from an arbitrarily chosen date. It should be noted that such table will be used for subsequent invoicing operations by the advertisers according to the number of confirmed display.

In an alternative solution of the operation 404, during the checking by the server that the user has already displayed one or several advertising spot(s) on that very day, if it appears that the user 1 who opens his/her Internet browser for the second time in the day effectively displayed an advertising spot which he/she validated by completing the visual cryptogram positioned at the bottom of the advertising spot displayed, the reaction of the server 200 to this information depends on the offer which the user 1 subscribed to.

If the user 1 subscribed to the program by selecting to display only one advertising spot per 24 hours, the server 200 will reorient the user's 1 computer 100 browser towards its former Internet homepage having the address URLd without displaying any new advertising spot. The steps 405 to 410 recently described hereabove will be omitted.

On the contrary, if the user 1 subscribed to the program by selecting to display advertising spots upon each opening of his/her Internet browser without any limitation of the number of messages per 24 hours, the steps 1 to 10 described hereabove will be carried out as often as the user opens his/her Internet browser.

Conventionally, Internet users regularly erase the cookies on their computers in order to prevent viruses and other attacks. In this case, his/her public key and his/her ClientId unique identifier are lost. When the user 1 connects to the Internet at step 401, the server 200 cannot detect his/her ClientId unique identifier and thus cannot send him/her a customised homepage P_{dip}.

The server 200 then sends during a step 411 an identification Pid including requests for his/her name, Christian name, address, email address, bank account number. As soon as the identification is validated through a comparison-based data stored in the “users_table” table, the server 200 generates in a step 412 a new pair of public and private keys and sends the user's 1 computer 100 a new “key_cookie” file and a new “data_cookie” file. The server 200 stores a private key in the “private_keys” table of its memory 203.

The user 1 can then have access to the Internet during steps 401 to 410 of the assumption 1 described hereabove.

As illustrated in FIG. 3, above completion of step 410, the server 200 reorients the user's 1 computer 100 Internet browser towards its former Internet homepage having an URLd address.

The procedure is similar to what has just been described in the case where both keys matching test (step 403) fails, whatever the reason.

In an alternative solution of step 407, the user 1 assigns each advertising received one or several quality marks and pertinence marks with respect to his/her own tastes, such mark being retransmitted towards the server 200 at the same time as the restranscribed text of the visual cryptogram. The server 200 stores the marks associated to the series of information transmitted to said user 1. In such alternative solution, during the access to the service by another user 1b whose perceptual preferences are close to that of the user 1, the server 200 may preferably send him/her the advertising which received the best marks by the user 1.

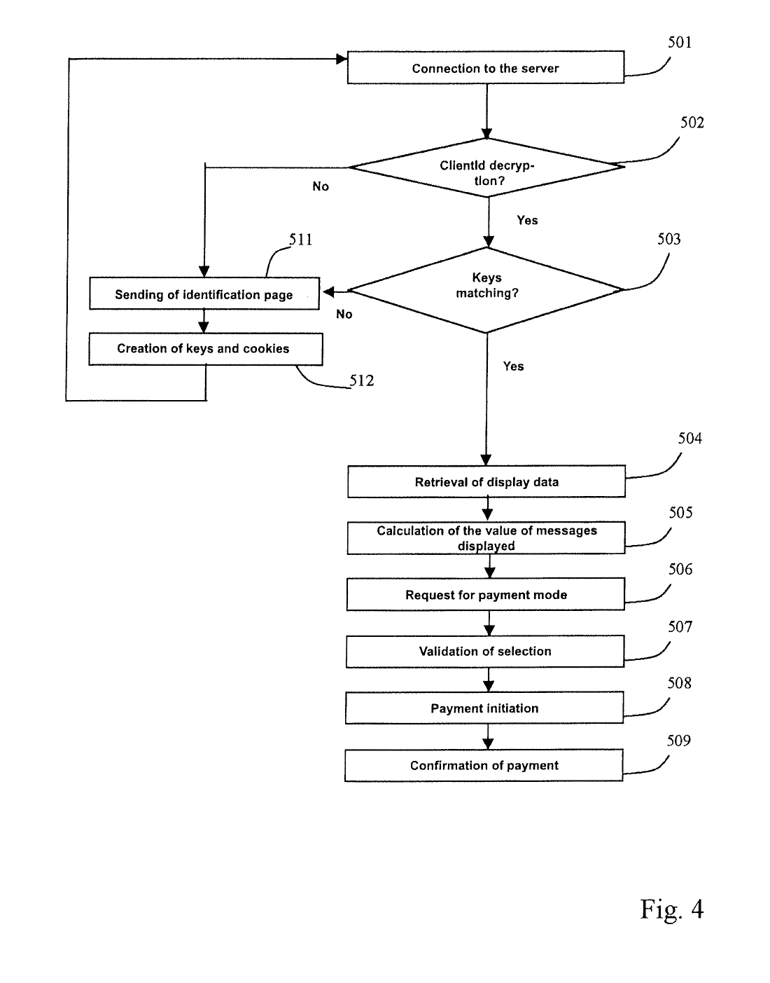

FIG. 4 synoptically illustrates the regular updating of parameters of the user's account.

When the user 1 wishes to obtain the payment of the sum to be paid to the user as a counterpart for the advertisement spot(s) displayed during an operation 501, he gets connected to the server_site Internet site and requests the payment for his/her displaying the targeted advertising spots sent to him/her by the server by clicking on an icon corresponding to such request.

During an operation 502, identical to the above operation 402, the server 200 decrypts the user's 1 ClientId unique identifier contained in the user's “key_cookie” file with his/her public key and authenticates the user's 1 key contained in the “key_cookie” file.

During an operation 503, identical to the operation 403 above, the server 200 checks that the pair of public and public keys really matches the user 1 by encrypting and then decrypting the information contained in the “key_cookie” file.

During an operation 504, the server 200 collects the “display_history” and “accounting_data” tables stored in its memory 103, information corresponding to the user 1 identified through his/her unique identifier IdClient, among which appears the number of series of information (advertisement spots) viewed by the user 1 as from an arbitrarily selected date.

During an operation 505, on the basis of information contained in the “display_history” table, the server 200 calculates the number of advertising spots viewed by the user 1 as from the last payment made to the user 1, the last payment and the date they have been stored in the “accounting_data” table. The server 200 calculates the sum due to the user 1 as a function of the value associated to each series of information displayed and the number of displays.

During an operation 506, the server 200 sends the user's 1 computer 100 browser a page P_{payment} of the conventional type containing the indication of the sum due, an invitation to the user to indicate the payment mode he/she uses (for example: cheque, money transfer etc. . . . ) and a visual cryptogram for the validation of the request for payment.

During an operation 507, the user 1 indicates the payment mode he/she has chosen and validates his/her request for payment by retranscribing the visual cryptogram included in the page P_{payment}.

During an operation 508, the server 200 launches a process for paying the user 1 according to an automatic procedure or through a message to a service including a human checking. The server 200 updates the “accounting_data” table corresponding to the user 1.

During an operation 509, the server 200 confirms the user 1 that his/her request for payment has been recorded by sending a thank you page Pᵣₑₘ.

Then again, if the user's ClientId unique identifier is not recognised or if the public and private keys matching test fails, a procedure similar to steps 411 and 412 is launched.

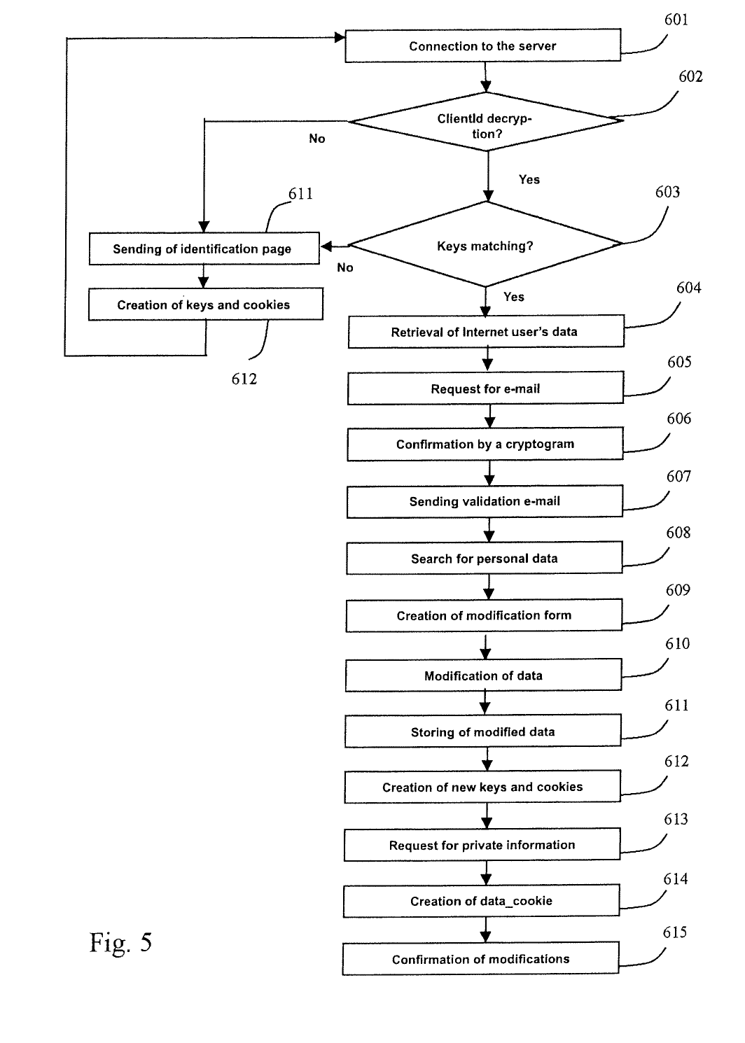

FIG. 5 synoptically illustrates the user's data modification method.

When the user 1 wishes to modify his/her personal data, during an operation 601, he/she connects to the Internet site “server_site” and requests an examination of his/her user's account in order to modify the personal and private data by clicking on an icon corresponding to this request.

During an operation 602, identical to operation 402 above, the server 200 disencrypts the user's 1 ClientId unique identifier contained in the user's “key_cookie” file using its public key and authenticates the user 1 key contained in the “key_cookie” file.

During an operation 603, identical to the operation 403 above, the server 200 checks that the pair of public and private keys does match the user 1 by encrypting and decrypting the information contained in the “key_cookie” file.

During an operation 604, the server 200 retrieves the personal and private information corresponding to the user 1 stored in the “users_table” table on the server 200.

During an operation 605, the server 200 reorients the user's 1 computer 100 in Internet browser to a secured page Pₘₐᵢₗ containing a form for entering an email as well as a visual cryptogram for the validation of its request for the “examination of the user's account”.

During an operation 606, the user 1 fills this form by entering an email address identical to that which he/she indicated upon his/her subscription to the program and validates the form by retranscribing the visual cryptogram appearing on said form.

During an operation 607, the server 200 sends the user 1 an email containing an hypertext link towards a secured page P_{account} of the site which makes it possible to retrieve one's account through the user 1. Such operation is of conventional type. The user 1 clicks on such hypertext link to validate the correct reception of the mail.

During an operation 608, the server 200 searches in the “users_table” table of its database, the personal data associated to the user's 1 email address (or to his/her ClientId unique identifier). Assuming that the server 200 finds no data associated to the email address given by the user 1, the server 200 would reorient the user's 1 computer 100 browser towards the homepage Pₐ and the “server_site” Internet site program subscription.

During an operation 609, the server 200 generates and sends the user's 1 computer 100 browser an Internet page P_{data} including a pre-filled modifiable form bearing the personal data filled by the user 1 upon his/her subscription to a program and stored by the server 200 from this date in the “users_table” table. Such form contains a conventional visual cryptogram for the validation of the form.

During an operation 610, the user 1 modifies as he wishes the pre-filled information of such form depending on the changes which occurred since he/she subscribed to this program. Then, the user 1 validates the modified form via the included visual cryptogram.

During an operation 611, the server stores the user's 1 updated data in the “users_table” table.

During an operation 612, the server 200 generates a new pair of encryption (public and private keys). It sends the new public key and the user's 1 new ClientId unique identifier encrypted by the private key stored on the server 200 in the “private_key” table as a “key_cookie” file to the user's 1 computer 100 browser. The server 200 then defines a new URLip address for the user's 1 customised Internet launching page P_{dip}.

During an operation 613, the server 200 sends the user's 1 browser a page of private information Pᵢₚ including an interactive form for the request f private for information, such page being of a secured type. Such form prompts the user 1 to supply private data among which more particularly:

Name;

Christian name;

Address;

Banking account.

During an operation 614, the user 1 fills the form and validates it by clicking on a form validation target icon. The private data contained in the form are encrypted by the server 200 using the user's 1 private key, they are sent again to the user's 1 computer 100 Internet browser in the form of a cookie stored in a “data_cookie”.

During an operation 615, the server 200 confirms it took into account the request for modification of the data in the user's account 1 in the form of an Internet acknowledgement page Pᵣₑₘ.

Then again, if the user's 1 ClientId unique identifier is not recognised or if the public and private keys matching test fails, a procedure similar step 411 and 412 is launched.

It will be understood upon reading the preceding description that the disclosed embodiments make it possible to solve the problem of non targeted advertising spams which are received in numbers by Internet users. In this disclosed embodiment, on the contrary, a relation is created between the Internet user and the targeted advertising he/she accepts to receive through the selection of initial preference criteria and the professionals with whom he/she is possibly connected with.

The scope of the disclosed embodiments are not limited to the details of the embodiments mentioned hereabove as examples but on the contrary extends to the modifications within the scope of the persons skilled in the art.

1. A method for transmitting information between an emitter and a receiver, including:
a phase of authentication of the receiver using a pair of encryption keys of the private key/public key types,
a phase of sending a series of information from the emitter to the receiver,
a phase of retransmission by the receiver to the emitter of an acknowledgement of receipt including at least one element semantically associated with the series of information transmitted.

2. A method according to claim 1, wherein the emitter is a server of digitalized files.

3. A method according to claim 1, wherein the element semantically associated with the series of information transmitted is a text transmitted by the emitter as an image.

4. A method according to claim 1, wherein the element semantically associated with a series of information transmitted is an answer to a question transmitted with the series of information, with the answer being contained in the series of information transmitted.

5. A method according to claim 1, wherein the receiver is of the computer type, and provided with Internet pages display means, and in that the phase of sending the series of information uses a transmission protocol of the Internet type, the series of information being formatted as Internet pages.

6. A method according to claim 5, wherein the public key is stored in a memory of the receiving computer and the private key is stored in a memory of the files server.

7. A method according to claim 1, wherein it includes a phase of storing the information transmitted to each receiver by the emitter.

8. A method according to claim 7, wherein the emitter includes a memory, wherein a table is stored, associating a value with each series of information transmitted, and a memory associated with each receiver, wherein the list of the series of information transmitted to said receiver, the date of transmission of each of the series of information, the sum of the values associated with the series of information transmitted to this receiver from the summation start date, and the summation start date are stored.

9. A method according to claim 8, wherein the emitter includes a memory wherein a set of data characterizing the receiver is stored, and a memory wherein, for each series of information liable to be transmitted, a set of data characterizing this series is stored.

10. A method according to claim 9, wherein it includes a phase of selecting at least one series of information to be transmitted to the receiver according to criteria associating the data characterizing the receiver, the data characterizing the series of information liable to be transmitted and the list of the series of information previously transmitted to said receiver.

11. A method according to claim 10, wherein it includes a phase of updating the data characterizing the receiver.

12. A method according to claim 11, wherein the updating uses an estimation by the receiver of each series of information received, and a storing by the emitter of the estimations associated with the series of information transmitted to said receiver.

13. A method according to claim 5, wherein the receiving computer includes a memory, wherein information able to cause the priority connection with the emitter upon access of the receiver to the Internet network is stored.

14. A method for transmitting one or several advertising spots through a server of files to the computer of an Internet user, said advertising spots being formatted within an Internet page, wherein said advertising spots are associated with estimations according to n perceptual dimensions, such estimations being stored in a memory of the server, and in that it includes:
a step of creating an account wherein:
the user gives his/her name and address and his/her preferences according to the n perceptual dimensions,
a couple of encryption keys of the public key/private key types is generated, the public key being stored in a memory of the user's computer together with a unique identifier encrypted with the private key, and the private key is stored in a memory of the server together with the unique identifier,
a step of a so-called daily utilization of the service during which:
the user's computer is connected via the Internet to the server of the service and sends thereto its encrypted unique identifier and its public key,
the server decrypts the unique identifier using the public key, then retrieves from its memory the private key associated with the unique identifier and tests the matching of both keys,
the server selects one or several advertising spots on the closeness to the user's perceptual preferences, then generates an Internet page including this or these advertising spot(s), as well as a visual cryptogram and sends it (them) to the user,
the user retranscribes the content of the visual cryptogram and the server confirms the correct matching of the retranscribed content with the original content and stores the correct display of this or these advertising spot(s) by the user on the date of the day in its memory.

15. A method according to claim 14, wherein the content of the visual cryptogram is a semantic element retrieved from the transmitted advertising spot(s).
